(19) United States
(12) Patent Application Publication
(10) Pub. No.: US 2012/0013760 A1
(43) Pub. Date: Jan. 19, 2012

(54) CHARACTERIZATION OF IMAGE SENSORS

(75) Inventors: Pierre-Jean Parodi-Keravec, Lattes (FR); Iain McAllister, Cheshire (GB)

(73) Assignee: STMicroelectronics (Research & Development) Limited, Marlow (GB)

(21) Appl. No.: 13/181,103

(22) Filed: Jul. 12, 2011

(30) Foreign Application Priority Data
Jul. 16, 2010 (GB) 1011974.1

(51) Int. Cl. H04N 5/228

(52) U.S. Cl. 348/222.1; 348/E05.024

(57) ABSTRACT

A camera module characterization method is presented. An object is imaged with the camera module. The object may be a test chart including a pattern that defines edges and markers. A resolution metric is measured from the obtained image, and at least one point where the resolution metric is maximized is identified (indicative of a measured in-focus position). The measured in-focus position is then used to derive optical aberration parameters. With respect to the test chart, the markers in the image are located and compared with known theoretical marker positions. A difference between the theoretical and actual marker positions is calculated and used to determine edge locations. A measurement of a resolution metric is then made from the obtained image at the determined edge locations.

### PRIORITY CLAIM

This application claims priority from United Kingdom Application for Patent No. 1011974.1 filed Jul. 16, 2010, the disclosure of which is hereby incorporated by reference.

### TECHNICAL FIELD

The present invention relates to improvements in or relating to the characterization of image sensors, in particular digital image sensors, and camera modules that comprise digital image sensors.

### BACKGROUND

Digital image sensing based upon solid state technology is well known, the two most common types of image sensors currently being charge coupled devices (CCD's) and complementary metal oxide semiconductor (CMOS) image sensors. Digital image sensors are incorporated within a wide variety of devices throughout the consumer, industrial and defense sectors among others.

An image sensor is a device comprising one or more radiation sensitive elements having an electrical property that changes when radiation is incident upon them, together with circuitry for converting the changed electrical property into a signal. As an example, an image sensor may comprise a photodetector that generates a charge when radiation is incident upon it. The photodetector may be designed to be sensitive to electromagnetic radiation in the range of (human) visible wavelengths, or other neighboring wavelength ranges, such as infra red or ultra violet for example. Circuitry is provided that collects and carries the charge from the radiation sensitive element for conversion to a value representing the intensity of incident radiation.

Typically, more than one radiation sensitive element will be provided in an array. The term pixel is used as a shorthand for picture element. In the context of a digital image sensor, a pixel refers to that portion of the image sensor that contributes one value representative of the radiation intensity at that point on the array. These pixel values are combined to reproduce a scene that is to be imaged by the sensor. A plurality of pixel values can be referred to collectively as image data. Pixels are usually formed on and/or within a semiconductor substrate. In fact, the radiation sensitive element comprises only a part of the pixel, and only part of the pixel's surface area (the proportion of the pixel area that the radiation sensitive element takes up is known as the fill factor). Other parts of the pixel are taken up by metallization such as transistor gates and so on. Other image sensor components, such as readout electronics, analog to digital conversion circuitry and so on may be provided at least partially as part of each pixel, depending on the pixel architecture.

A digital image sensor is formed on and/or within a semiconductor substrate, for example silicon. The sensor die can be connected to or form an integral subsection of a printed circuit board (PCB). A camera module is a packaged assembly that comprises a substrate, an image sensor and a housing. The housing typically comprises one or more optical elements, for example, one or more lenses.

Camera modules of this type can be provided in various shapes and sizes, for use with different types of device, for example mobile telephones, webcams, optical mice, to name but a few.

Various other elements may be included as part of the module, for example infra-red filters, lens actuators and so on. The substrate of the module may also comprise further circuitry for read-out of image data and for post processing, depending upon the chosen implementation. For example, in so called system-on-a-chip (SoC) implementations, various image post processing functions may be carried out on a PCB substrate that forms part of the camera module. Alternatively, a co-processor can be provided as a dedicated circuit component for separate connection to and operation with the camera module.

One of the most important characteristics of a camera module (which for the present description, can simply be referred to as a “camera”) is the ability of the camera to capture fine detail found in the original scene. The ability to resolve detail is determined by a number of factors, including the performance of the camera lens, the size of pixels and the effect of other functions of the camera such as image compression and gamma correction.

Various different metrics are known for quantifying the resolution of a camera or a component of a camera such as a lens. These metrics involve studying properties of one or more images that are produced by the camera. The measured properties thus represent the characteristics of the camera that produces those images. Resolution measurement metrics include, for example, resolving power, limiting resolution (which is defined at some specified contrast), spatial frequency response (SFR), modulation transfer function (MTF) and optical transfer function (OTF).

The point spread function (PSF) describes the response of a camera (or any other imaging system) to a point source or point object. This is usually expressed as a normalized spatial signal distribution in the linearized output of an imaging system resulting from imaging a theoretical infinitely small point source.

The optical transfer function (OTF) is the two-dimensional Fourier transform of the point spread function. The OTF is a complex function whose modulus has unity value at zero spatial frequency. The modulation transfer function (MTF) is the modulus of the OTF. The MTF also refers to spatial frequency response (SFR) however in fact the concept of SFR is the concept of MTF extended to image sampling systems which integrates part of the incoming light across an array of pixels, that is, the SFR is a measure of the sharpness of an image produced by an imaging system or camera that comprises a pixel array.

The resolution of a camera is generally characterized using reference images which are printed on a test chart. The test chart may either be transmissive and be illuminated from behind, or reflective and be illuminated from in front with the image sensor detecting the reflected illumination. Test charts include patterns such as edges, lines, square waves or sine wave patterns for testing various aspects of a camera's performance. FIG. 1 shows a test chart for performing resolution measurements of an electronic still picture camera as defined in ISO 12233. The chart includes, among other features, horizontal, vertical and diagonally oriented hyperbolic wedges, sweeps and tilted bursts, as well as a circle and long slightly slanted lines to measure geometric linearity or distortion. These and other features are well known and described within the body of ISO 12233:2000, which is incorporated herein by reference to the maximum extent allowable by law.

Once a camera has been manufactured, its resolution needs to be tested before it is shipped. The measured resolution metrics must meet certain predetermined thresholds in order for the camera to pass its quality test and to be shipped out for sale to customers. If the predetermined thresholds for the resolution metrics are not met, the camera will be rejected because it does not meet the minimum standards defined by the thresholds. There are various factors that can cause a camera to be non-compliant, including for example faults in the pixel array, such as an unacceptably high number of defective pixels; faults in the optics such as lens deformations; faults in the alignment of components in the assembly of the camera module; ingress of foreign matter such as dust particles or material contaminants during the assembly process; or excessive electromagnetic interference or defectivity in electromagnetic shielding causing the pixel array to malfunction.

Resolution is measured by detecting the edges of a test chart and measuring the sharpness of those edges. Because the pixels in the array are arranged in horizontal and vertical rows and columns, the edge detection generally works best when the edges are aligned in a horizontal and vertical directions, that is, when they are aligned with the rows and columns of the pixel array.

It has also been proposed to use diagonal edges for edge detection. For example, Reichenbach et al., “Characterizing Digital Image Acquisition Devices”,

Optical Engineering, Vol. 30, No. 2, February 1991 (the disclosure of which is incorporated by reference) provides a method for making diagonal measurements, and in principle, measurements at an arbitrary angle. This method relies on interpolation of pixel values, because the pixels on the diagonal edge do not lie along the horizontal and vertical scan lines that are used. The interpolation can introduce an additional factor contributing to degradation of the overall MTF.

U.S. Pat. No. 7,499,600 to Ojanen et al. (the disclosure of which is incorporated by reference) discloses another method for measuring angled edges which avoids the interpolation problems of Reichenbach's method, and which can be understood with reference to FIG. 2. The technique is applied to measure an edge 200 which is inclined with respect to an underlying pixel array, the pixels of which are represented by grid 202 and which define horizontal rows and vertical columns. Although shading is not shown in the diagram for the purposes of clarity, it will be appreciated that the edge defines the boundary between two regions, for example a dark (black) region and a light (white) region. A rotated rectangular region of interest (ROI) 204 is determined, which has a first axis parallel to the edge 200 and a second axis perpendicular to the edge 200. An edge spread function is determined at points along lines in the ROI in the direction perpendicular to the edge, using interpolation. Then, the line spread function (LSF) is computed at points along the lines perpendicular to the edge. Centroids for each line are computed, and line or a curve is fitted to the centroids. Coordinates in a rotated coordinate system are then determined of each imaging element in the ROI 204, and a supersampled ESF is determined along the axis of the ROI that is perpendicular to the edge 200. This ESF is binned and differentiated to obtain a supersampled LSF, which is Fourier transformed to obtain the MTF.

U.S. Pat. No. 7,499,600 (the disclosure of which is incorporated by reference) mentions that the measurement of MTF using edges inclined at large angles with respect to the horizontal and vertical can be useful to obtain a good description of the optics of a digital camera.

However, some characteristics of the camera depend on the characteristics of the optical elements (typically comprising one or more lenses).

The measured MTF or other resolution metric results from effects of the image sensing array and from effects of the optical elements. It is not possible to separate out these effects without performing separate measurements on two or more of the optical elements in isolation, the image sensing array in isolation, or the assembled camera. For example, it may be desirable to measure or test for optical aberrations of the optical elements, such as, for example, lens curvature, astigmatism or coma. At present, the only way to do this is to perform a test on the optical elements themselves, in isolation from the other components. A second, separate test, then needs to be carried out. This is usually carried out using the assembled camera module although it may also be possible to perform the second test on the image sensing array and then combine the results to calculate the resolution characteristics of the overall module.

Carrying out two separate tests in order to obtain information about optical aberrations of the optical elements is however time consuming, which impacts on the yield and profitability of a camera manufacturing and testing process.

Furthermore, the measurement of the camera resolution during the manufacturing process impacts upon the throughput of devices that can be produced. At present, the algorithms and processing involved can take around a few hundred milliseconds. Any reduction in this time would be highly advantageous.

### SUMMARY

According to a first aspect of this disclosure, there is provided a method of characterizing a camera module that comprises an image sensor and an optical element, comprising imaging an object with the camera module; measuring a resolution metric from the obtained image; determining the point or points where the resolution metric is maximized, representing an in-focus position; and using the measured focus positions to derive optical aberration parameters.

According to a second aspect of this disclosure, there is provided a method of characterizing a digital image sensing device comprising: imaging a test chart with the digital image sensing device, said test chart comprising a pattern that defines a plurality of edges, and a plurality of markers; locating said markers in the image obtained by the digital image sensing device; comparing the measured marker positions with known theoretical marker positions; calculating a difference between the theoretical and actual marker positions; determining edge locations based on said calculated difference; and measuring a resolution metric from the obtained image at the edge locations thus determined.

According to a third aspect of this disclosure, there is provided apparatus for the characterization of a digital image sensing device comprising a test chart, a mount for holding a digital image sensing device, and a computer connectable to a digital image sensing device to receive image data from the device and to perform calculations for the performance of the method of any of the first or second aspects.

According to a fourth aspect of this disclosure, there is provided a computer program product downloaded or downloadable onto, or provided with, a computer that, when executed, enables the computer to perform calculations for the performance of the method of the first or second aspects.

The computer program product can be downloaded or downloadable onto, or provided with, a computing device such as a desktop computer, in which case the computer that comprises the computer program product provides further aspects of the invention.

The computer program product may comprise computer readable code embodied on a computer readable recording medium. The computer readable recording medium may be any device storing or suitable for storing data in a form that can be read by a computer system, such as for example read-only memory (ROM), random-access memory (RAM), CD-ROMs, magnetic tapes, floppy disks, optical data storage devices, and carrier waves (such as data transmission through packet switched networks such as the Internet, or other networks). The computer readable recording medium can also be distributed over network coupled computer systems so that the computer readable code is stored and executed in a distributed fashion. Also, the development of functional programs, codes, and code segments for accomplishing the present invention will be apparent to those skilled in the art to which the present disclosure pertains.

### BRIEF DESCRIPTION OF THE DRAWINGS

The present invention will now be described, by way of example only, with reference to the accompanying drawings in which:

FIG. 1 shows a resolution test chart according to the ISO 12233:2000 standard;

FIG. 2 illustrates aspects of a prior art method for measuring an edge that is at a large angle of inclination with respect to the horizontal and vertical axes defined by the rows and columns of a pixel array forming part of a camera module;

FIG. 3 illustrates a known camera module;

FIG. 4 is a perspective view of the module of the FIG. 3;

FIGS. 5 and 6 illustrate a known process for extracting a 45 degree edge;

FIG. 7 illustrates a test chart according to an aspect of the present disclosure;

FIG. 8 illustrates the different focus positions of light at different wavelengths;

FIG. 9 illustrates Through Focus Curves for light at different wavelengths;

FIG. 10 illustrates a Through Focus Curve for a representative single color channel;

FIG. 11 illustrates the equivalence of moving the sensor and moving the object in terms of the position on a Through Focus Curve;

FIG. 12 illustrates the position of two object to lens distances on a Through Focus Curve;

FIG. 13 illustrates the fitting of a function to a Through Focus Curve, in this example a Gaussian function;

FIGS. 14 and 15 illustrate the phenomenon of field curvature;

FIGS. 16, 17 and 18 illustrate the phenomenon of astigmatism;

FIG. 19 illustrates the phenomenon of image plane tilt relative to the sensor plane;

FIG. 20 shows an example of spatial frequency response contour mapping in a sagittal plane;

FIG. 21 shows an example of spatial frequency response contour mapping in a tangential plane; and

FIG. 22 shows an example apparatus incorporating the various aspects mentioned above of the present invention.

### DETAILED DESCRIPTION OF THE DRAWINGS

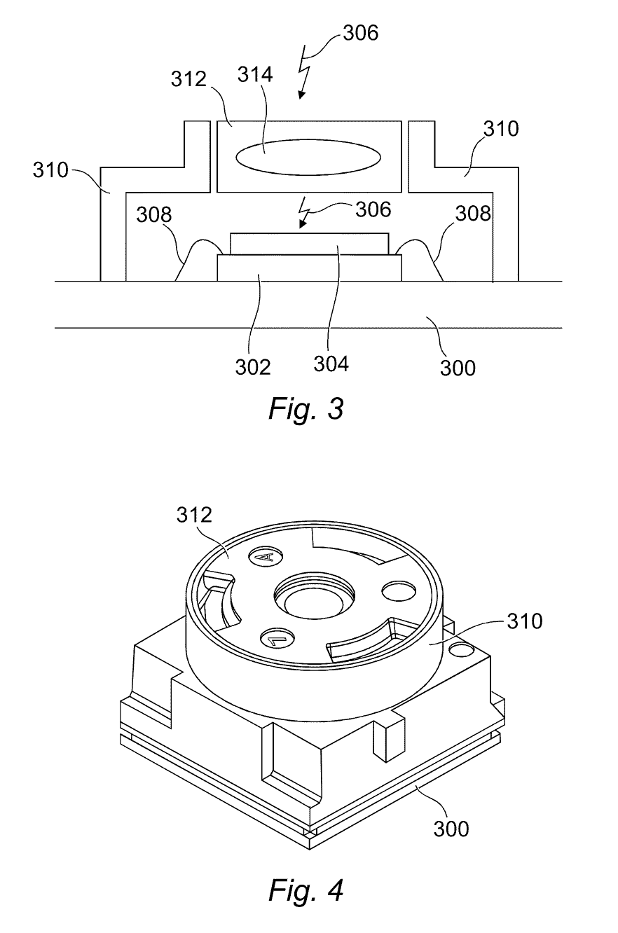

FIG. 3 shows a typical camera module of the type mentioned above.

Selected components are shown for ease of illustration in the present disclosure and it is to be understood that other components could be incorporated into the structure. A substrate 300 is provided upon which an imaging die 302 is assembled. The substrate 300 could be a PCB, ceramic or other material. The imaging die 302 comprises a radiation sensitive portion 304 which collects incident radiation 306. For an image sensor the radiation sensitive portion will usually be photosensitive and the incident radiation 306 will usually be light including light in the (human) visible wavelength ranges as well as perhaps infrared and ultraviolet. Bond wires 308 are provided for forming electrical connections with the substrate 300. Other electrical connections are possible, such as solder bumps for example. A number of electrical components are formed in the body of the imaging die 302 and/or the substrate 300. These components control the image sensing and readout operations and are required to switch at high speed. The module is provided with a mount 310, a lens housing 312 and lens 314 for focusing incident radiation 306 onto the radiation sensitive portion of the image sensor. FIG. 4 shows a perspective view of the apparatus of FIG. 3, showing the substrate 300, mount 310, and lens housing 312.

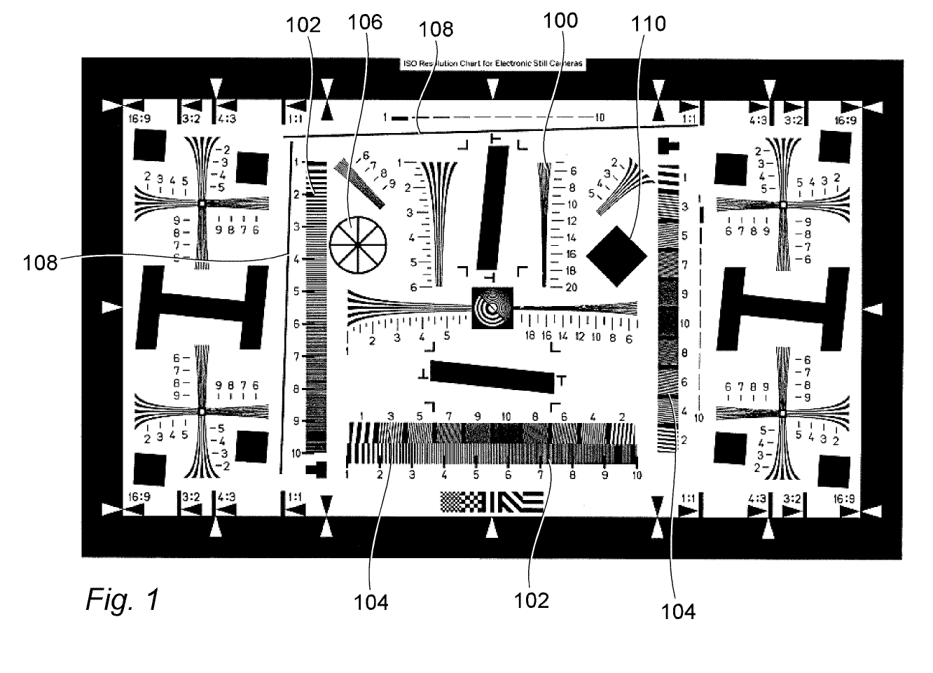

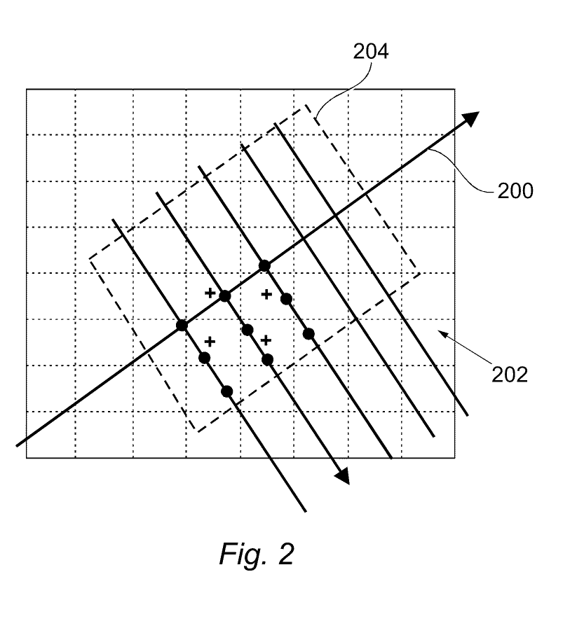

As mentioned above, the SFR (or MTF) provides a measurement of how much an image is blurred. The investigation of these characteristics is carried out by studying the image of an edge. By looking at an edge, one can determine the blurring effect due to the whole module along a direction perpendicular to the edge. FIG. 1 shows the standard resolution chart set out in ISO 12233:2000 which as mentioned above comprises, among other features, horizontal, vertical and diagonally oriented hyperbolic wedges (example shown at 100), sweeps 102 and tilted bursts 104, as well as a circle 106 and long slightly slanted lines 108 to measure geometric linearity or distortion. A test chart according to this standard comprises all or a selection of the elements illustrated in the chart. As well as resolution measurement some related measurements can be measured by the chart such as aliasing ratio and detection of artifacts such as scanning non-linearities and image compression artifacts. In addition, other markers can be used for locating the frame of the image.

The goal of this chart is to measure the SFR along a direction perpendicular or parallel to the rows of the pixel array of the image sensor. In fact, to measure an edge in the vertical or horizontal direction, the edges can optionally be slanted slightly, so that the edge gradient can be measured at multiple relative phases with respect to the pixels of the array, so that aliasing effects are minimized. The angle of the slant is “slight” in the sense that it must still approximate to a vertical or a horizontal edge—the offset from the vertical or the horizontal is only for the purposes of gathering multiple data values. The quantification of the “slight” inclines may vary for different charts and for different features within a given chart, but typically the angle will be between zero and fifteen degrees, usually around five degrees.

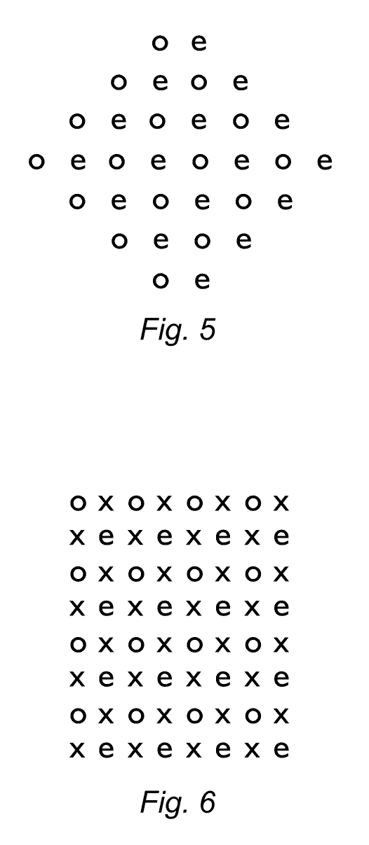

There are also features in the ISO chart that are for measuring diagonal SFR—see for example black square 110. FIGS. 5 and 6 illustrate how such features are used. A 45 degree rotated ROI (as illustrated by FIG. 5) is first rotated by 45 degrees to be horizontal or vertical, forming an array as shown in FIG. 6, in which the pixel pitch is the pixel pitch of the non-rotated image divided by √2. In FIGS. 5 and 6, the symbols “o” and “e” are used as arbitrary labels so that the angles of inclination of the pixel array can be understood. In FIG. 6, the symbol “x” denotes a missing data point, arising from the rotation. Furthermore, the number of data points for SFR measurement is limited because the chart has many features with different angles of inclination, meaning there is some “dead space” in the chart, that is, areas which do not contribute towards SFR measurement.

The inventors have proposed to make a chart in which a number of edges are provided, which comprise a first set of one or more edges along a radial direction and a second set of one or more edges along a tangential direction (the tangential direction is perpendicular to the radial direction). The edges may also be organized circularly, corresponding to the rotational symmetry of a lens. The circles can be at any distance from the center of the image sensor.

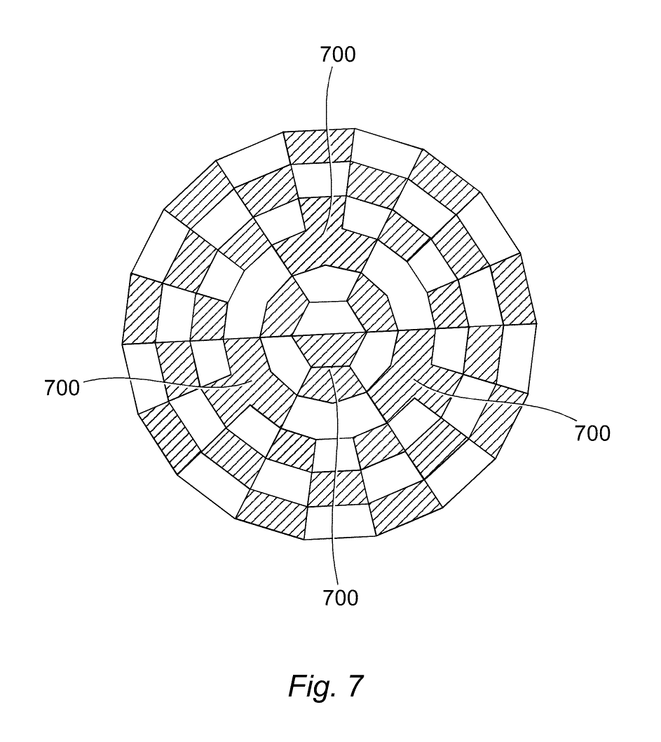

An example of a chart that meets this requirement is shown in FIG. 7. It is to be noted that when making a chart, the image of an edge must be of a size that allows for sufficient data to be collected from the edge. The size can be measured in pixels, that is, by the number of pixels in the pixel array that image an edge or a ROI along its length and breadth. The number of pixels will depend on and can be varied by changing the positioning of the camera with respect to the chart, and the number of pixels in the array. In an example embodiment, not limiting the scope of this disclosure, SFR is computed by performing a Fast Fourier Transform (FFT) of the ESF. A larger ESF results in a higher resolution of SFR measurement. Ideally, the signal for an FFT should be infinitely long, so an ROI that is too narrow will introduce significant error. When such techniques are used, the inventors have determined that the image of an edge should be at least 60 pixels long in each color channel of the sensor. Once a rectangular ROI is selected, the white part and the black part must be at least 16 pixels long (in one color channel). It is to be understood that these pixel values are for exemplification only, and that for other measurement techniques and for different purposes, the size of the images of the edges could be larger or smaller, as required and/or as necessary.

In the example of FIG. 7, the area of the chart illustrated is substantially filled by shapes that have edges that are either radial or tangential, thus achieving a better “fill factor”, that is, the number of SFR measurement points can effectively be maximized. Fill factor can be improved by providing one or more shapes that form the edges in a circular arrangement, and having the shapes forming the chart comprise only edges that lie along either a radial or tangential direction. If we assume that rows of the pixel array are horizontal and columns of the pixel array are vertical, it can be seen that an edge of any angle can used for edge detection and SFR measurement.

The edges of the chart should also be slightly offset from the horizontal and vertical positions—ideally by at least two degrees. The chart can be designed to ensure that, when slightly rotated or misaligned, say by up to ten degrees, the edges will all remain slightly offset from the horizontal and vertical positions, preferably preserving the same threshold of at least two degrees of offset. The edge gradient can be measured at multiple relative phases with respect to the pixels of the array, minimizing aliasing effects.

The edges may also be regularly spaced, as shown in this example chart.

In this example, the edges are regularly spaced in both a radial and a tangential direction. The advantage of having regularly spaced edges (in either or both of the radial and tangential directions) is that the SFR measurements are also regularly spaced. This means that it is easy to interpolate the SFR values over the area covered by the edges.

When the chart is rotationally symmetric, it can be rotated and still function. Moreover, the edges can be rotated by plus or minus 10 degrees from the radial or tangential directions and the invention would still work.

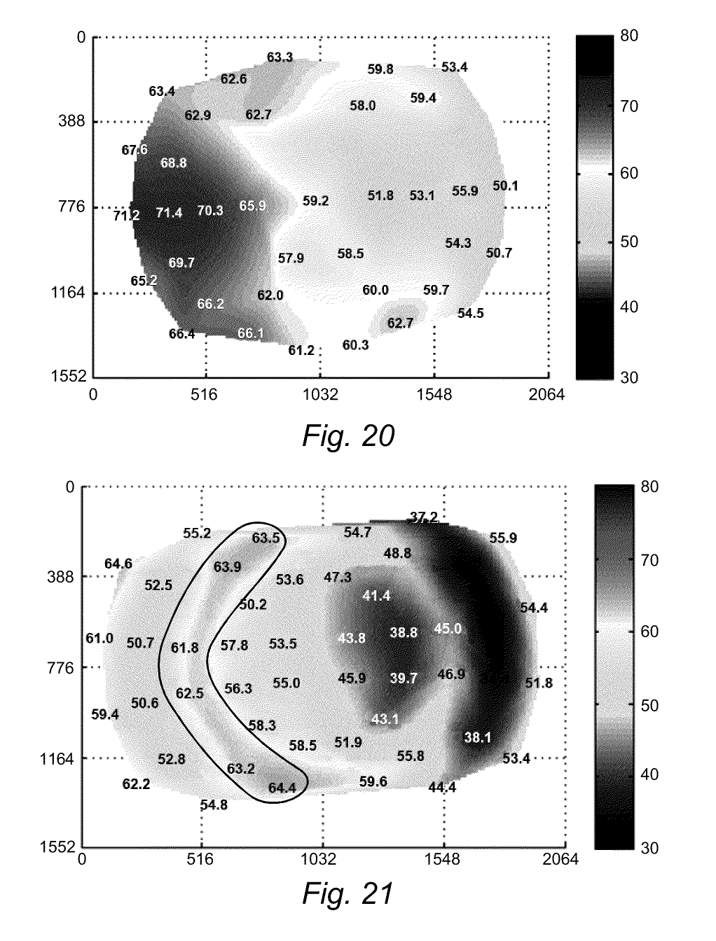

The SFR can be measured at various sample points. An appropriate sampling rate should be chosen, being high enough to see variation between two samples, but low enough not to be influenced significantly by noise. To this end, the inventors have chosen in the examples of FIGS. 20 and 21 (discussed later) to map the SFR at Ny/4, where Ny/4=1/(8*pixel_pitch)=0.125/pixel_pitch. It can be mapped at different spatial frequencies if required. (In signal processing, the Nyquist frequency, Ny, is defined as the highest frequency which can be resolved. Ny=1/(2*sampling_pitch)=1/(2*pixel_pitch)).

The SFR can be measured in all the relevant color channels that are applicable for a given sensor, for example red, green and blue color channels in the case of sensor that has a Bayer color filter array. Other color filtering and band selection schemes are known, and can be used with the chart. Also, signals derived from a mix of the color channels can be measured.

Various parameters can be derived from measurements of the variation in focus position between images of objects at different distances, and/or between different field positions. Each different positional arrangement of the object, the lens (or other equivalent camera module optical element or elements) and the sensor will correspond to a different focus position, and give different SFR values. The measured focus positions can then be used to derive parameters including field curvature, astigmatism and the tilt of the sensor relative to the image plane.

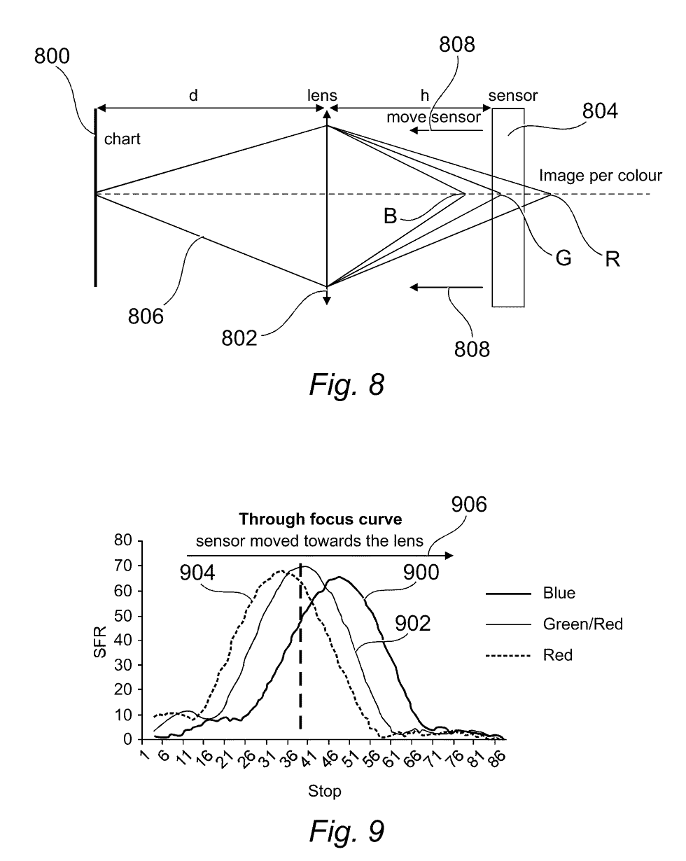

Resolution performance will be different at different focus positions. When out of focus, resolution is poor, and so is SFR. In focus, resolution is at its maximum and so is SFR. This is illustrated in FIG. 8, which shows a representation of the focusing of a light from an object 800 such as chart by a lens 802 on a sensor 804. The object 800 and lens 802 are separated by a distance d and the lens 802 and sensor 804 are separated by a distance h. Light 806 from the object 800 is focused at different distances depending on the frequency of the light. This is illustratively shown as different focus positions for blue (B) green (G) and red (R) light, as an illustration, in which blue is focused at a shorter position than green and red.

When the sensor 804 is moved with respect to the lens 802, the SFR of the resultant image will vary. The motion of the sensor is illustrated in FIG. 8 by arrows 808, and the resultant variations in SFR are shown in FIG. 9, which plots the SFR against lens-sensor separation (the h position). Curves 900, 902 and 904 correspond to the positions of the blue (B), green (G) and red (R) positions respectively, and the motion of the sensor is shown by arrow 906. The curves of SFR variation are known as Through Focus Curves (TFCs).

In the example of FIGS. 8 and 9 there is significant chromatic aberration, i.e. red, green and blue foci are visibly different. On other modules, chromatic aberration may not be significant. In such a case, the different curves would be overlaid. For ease of illustration, the following discussion will assume that a single Through Focus Curve exists, that is, that the effects of chromatic aberration are non-existent or negligible (note however that when there is a significant chromatic aberration, a comparison between results in each color channel can be used to increase the focus estimation accuracy).

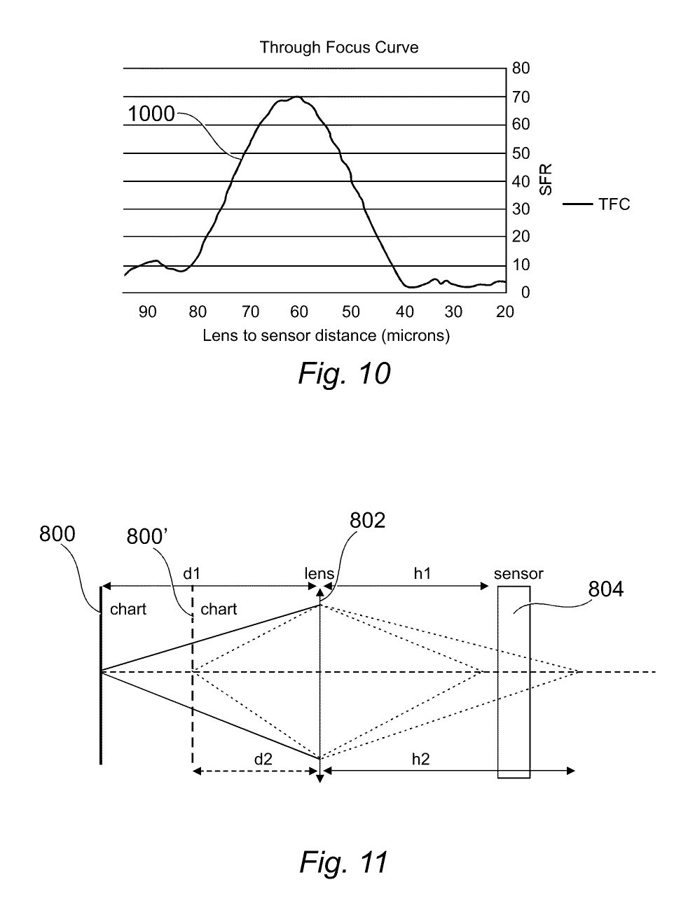

FIG. 10 therefore shows a Through Focus Curve 1000, representing the effect of moving the sensor 804 with respect to the lens 802 as previously described. The SFR is plotted against the lens-sensor separation (the h position). The values chosen for each axis are arbitrary values, chosen for illustration. The curve 1000 is obtained when the sensor 804 is moved toward the lens 802.

Now, there will also be different focus positions when the distance between the object 800 and lens 802 is varied. This is illustrated in FIG. 11, which shows an object 800 at a first position a distance dl from the lens 802, and, in dashed lines, a second position in which an object 800′ is at a second position d2 from the lens 802. As shown by the ray diagrams, when the object 800 is at a position dl relatively close to the lens 802, a focal plane is formed relatively far from the lens 802, in this illustration slightly beyond the sensor 804, at a position h1. Similarly, when the object 800′ is at a position d2 relatively far from the lens 802, a focal plane is formed relatively close to the lens 802, in this illustration slightly in front of the sensor 804, at a position h2.

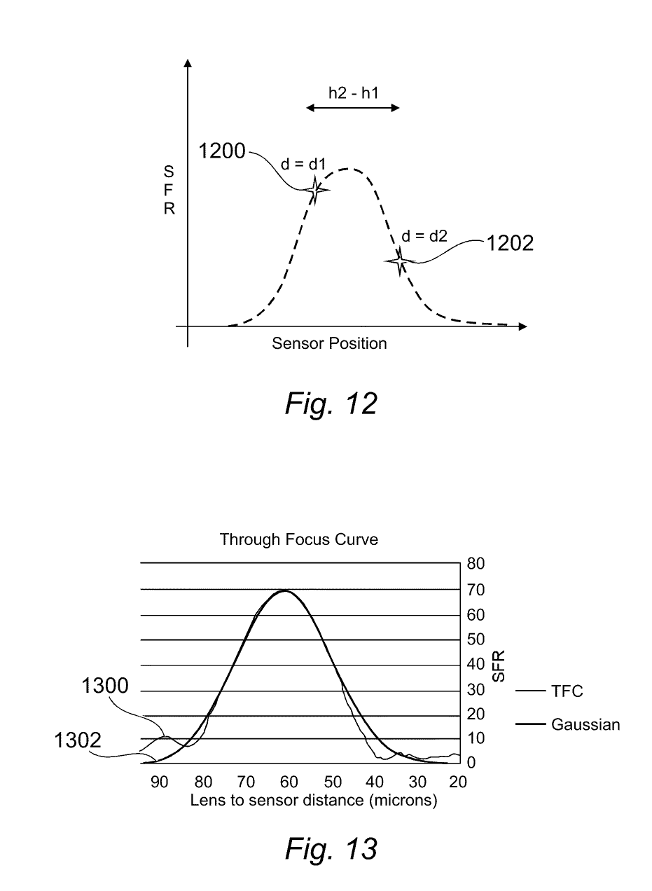

It can be seen therefore, that a Through Focus Curve can also be produced that represents movement of the object with respect to the lens. Furthermore, a Through Focus Curve obtained from the movement of the sensor with respect to the lens can be correlated with a Through Focus Curve obtained from the movement of the object with respect to the lens. This is illustrated in FIG. 12. This figure illustrates a Through Focus Curve showing the variation of SFR with the (h) position of the sensor 804. Point 1200 on this curve corresponds to the SFR as if the object 800 was at a position d1 as shown in FIG. 11, while point 1202 on the curve corresponds to the SFR as if the object 800′ was at a position d2 as shown in FIG. 11.

Therefore, a method of measuring the variation in focus position between images of objects at different distances, or between different field positions may comprise choosing two (or a different number) different object-lens distances (d). The distances can be chosen so that the two positions on the Through Focus Curves are separated at least by a predetermined amount, that ensures a measureable difference. Then, the difference H in distance between two corresponding sensor-lens distances is determined from design or measurement on lens (H=(h2−h1)). This may be done for example by achieving focus with an object placed at distance dl, and then moving the object to distance d2 and moving the lens until focus is achieved).

Then, a function which fits the TFC obtained from lens design or from measurement on a real lens may be used. A fitting function may be dispensed with if the TFC itself has a well defined shape, for example, if it is of a Gaussian shape.

Various functions can be used, so long as H=h2−h1 and a function f:h→f(TFC(h),TFC(h+H)) can be found so that f(h) is injective from real to real, that is, if ha and hb are different, T(ha) and T(hb) are different. The function should also fit the curve with sufficient precision required by the measurement on a range of object to lens distances which is likely to be used in the measurement.

A suitable function is a Gaussian function, the use of which is illustrated in FIG. 13. The lens-sensor (h distance) TFC 1300 is fit to the Gaussian function 1302.

The Gaussian function is given by

$$SFR ( h ) = A * {exp}^{\frac{{( h - μ )}^{2}}{{σ}^{2}}} .$$

In this example the peak, at position μ is 61.5, the amplitude A is 70 and the standard variation σ is 250. It fits the TFC on the range of values which will be tested, i.e. about the SFR peak. The peak, μ, is associated with an object-lens distance d when object is on focus. It is the metric of the focus position targeted in this technique. The standard deviation σ is assumed to be known. For example it can be constant across all parts manufactured. Then, by measuring the SFR at two different distances h1 and h2, the equation can be solved, as SFR(h1)=SFR1 and SFR(h2)=SFR2:

$$\frac{SFR ( h 1 )}{SFR ( h 2 )} = \frac{SFR 1}{SFR 2} = \frac{A \times {exp}^{\frac{{( h 1 - μ )}^{2}}{{σ}^{2}}}}{A \times {exp}^{\frac{{( h 2 - μ )}^{2}}{{σ}^{2}}}} = {exp}^{\frac{{( h 1 - μ )}^{2}}{{σ}^{2}} \frac{{( h 2 - μ )}^{2}}{{σ}^{2}}} \\ ( h 1 - μ ) 2 - {( h 2 - μ )}^{2} = {σ}^{2} * ln ( \frac{SFR 1}{SFR 2} )$$

$$μ - h 2 = \frac{H}{2} - \frac{{σ}^{2}}{2 H} * ln ( \frac{SFR 1}{SFR 2} )$$

Wherein, h2 is the lens to image distance of the image of an object on axis at distance d2 from the lens. It can be obtained from design or given by calibration and a TFC with d=d2. So the relative value μ−h2 can be converted into an absolute value p, representing the focus position.

The function is assumed to be the same over each field position x. However as an additional alternative, different functions can be used on each field position to get a more accurate result.

The function is assumed to be the same at different object to lens distances (equivalence of moving the chart and moving the sensor on the TFC illustrated on FIG. 11). But distinct functions TFC₁(h1) and TFC₂(h2) could be used, so long as so long as H=h2−h1 and a function f:h→f(TFC₁(h),TFC₂(h+H)) can be found so that f(h) is injective from real to real. The TFC itself can be used without a separate fitting function if it meets these conditions.

This technique can then be used to derive various parameters.

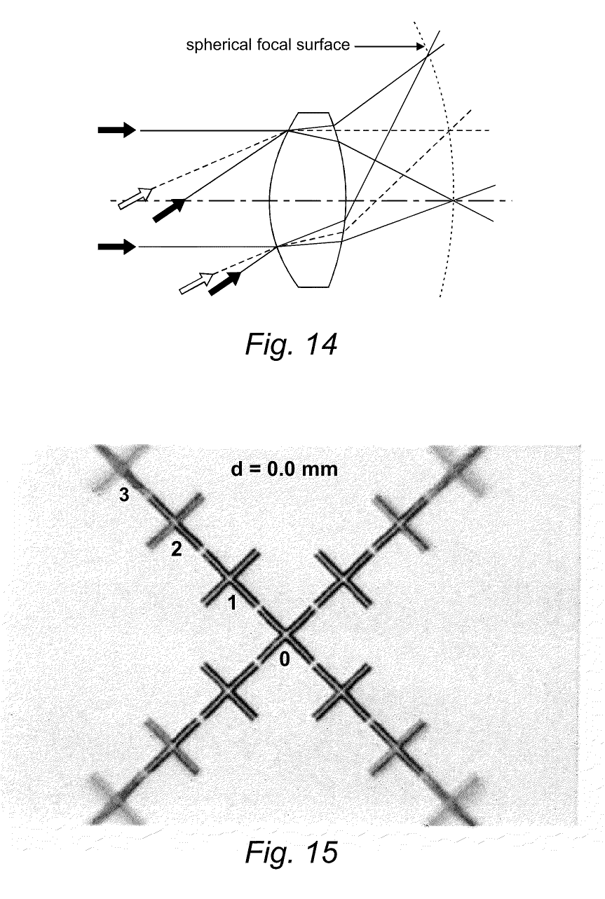

Field curvature is a deviation of focus position across the field. If a lens shows no asymmetry, field curvature should depend only on the field position. Field curvature is illustrated in FIG. 14, where images from differently angled objects are brought to focus at different points on a spherical focal surface, called the Petzval surface. The effect of field curvature on the image is to blur the corners, as can be seen in FIG. 15.

According to the present techniques, field curvature can be measured in microns and is the difference in the focus position at a particular field of view with respect to the center focus with a change towards the lens being in the negative direction. Let x be the field position, i.e. the ratio of the angle of incoming light to the Half-Field of View. SFR depends on x and also on the object to lens distance d, i.e. SFR(d,x), because of field curvature. p also depends on the field position x. If SFR is measured at different positions, the field curvature can then be obtained at different field positions. From SFR1(x) and SFR2(x), μ(x)−h2 can be derived. From SFR1(0) and SFR2(0), μ(0)−h2 can be derived. Then (μ(0)−h2)−(μ(x)−h2))=μ(0)−μ(x) is the distance between the focus position at the center and at field position x. That is, the SFR measurements can be used to derive focus position information at different points across the field of view, to build a representation of the field curvature. This representation can be compared with an ideal Petzval surface in order to identify undesired field curvature effects.

Another parameter that can be derived is astigmatism. An optical system with astigmatism is one where rays that propagate in two perpendicular planes (with one plane containing both the object point and the optical axis, and the other plane containing the object point and the center of the lens) have different foci. If an optical system with astigmatism is used to form an image of a cross, the vertical and horizontal lines will be in sharp focus at two different distances. The power variation is a function position of the rays from the aperture stop and only occurs off axis.

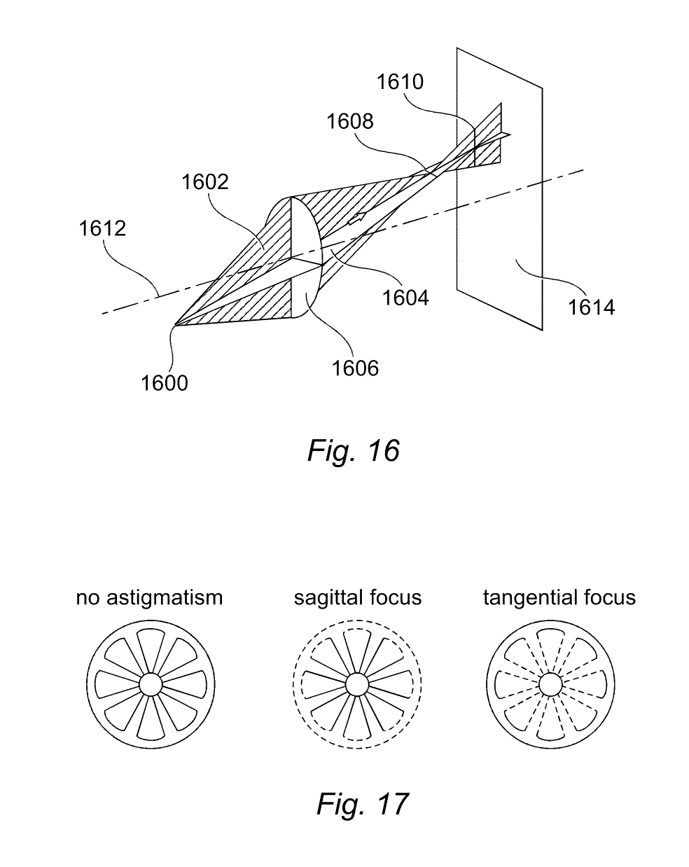

FIG. 16 illustrates rays from a point 1600 of an object, showing rays in a tangential plane 1602 and a sagittal plane 1604 passing through an optical element 1606 such as a lens. In this case, tangential rays from the object come to a focus 1608 closer to the lens than the focus 1610 of rays in the sagittal plane. The figure also shows the optical axis 1612 of the optical element 1606, and the paraxial focal plane 1614.

FIG. 17 shows the effect of different focus positions on an image. The left-side diagram in the figure shows a case where there is no astigmatism, the middle diagram shows the sagittal focus, and the right-side diagram shows the tangential focus.

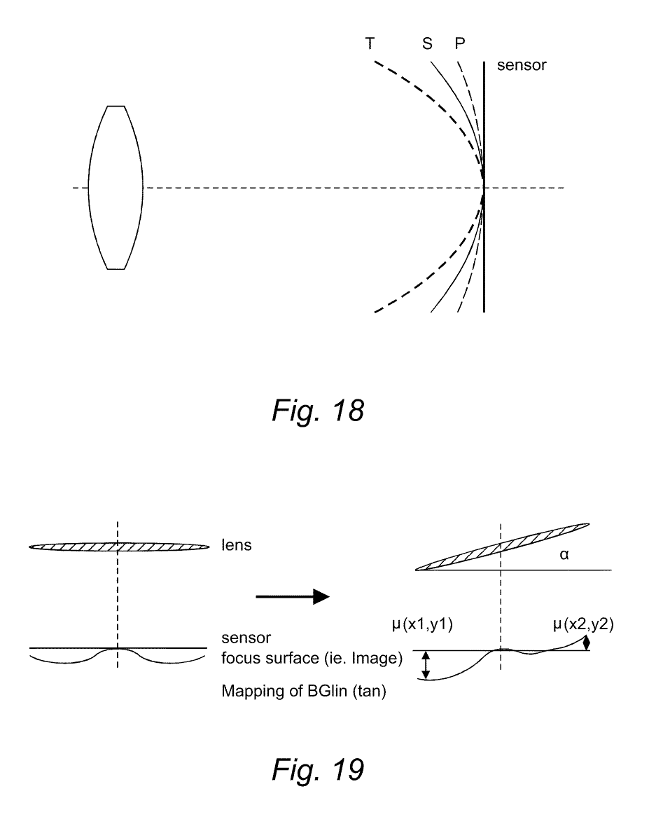

FIG. 18 shows a simple lens with undercorrected astigmatism. The tangential surface T, sagittal surface S and Petzval surface P are illustrated, along with the planar sensor surface.

When the image is evaluated at the tangential conjugate, we see a line in the sagittal direction. A line in the tangential direction is formed at the sagittal conjugate. Between these conjugates, the image is either an elliptical or a circular blur. Astigmatism can be measured as the separation of these conjugates. When the tangential surface is to the left of the sagittal surface (and both are to the left of the Petzval surface) the astigmatism is negative. The optimal focus position for a lens will lie at a position where Field Curvature and astigmatism (among other optical aberrations) are minimized across the field.

If SFR is measured on the same field position x but in sagittal and tangential directions, the astigmatism can be obtained at different field position. From SFR1(x,sag) and SFR2(x,sag), μ(x,sag)−h2 can be derived. From SFR1(x,tan) and SFR2(x,tan), μ(tan)−h2 can be derived. Then (μ(sag)−h2)−(μ(tan)−h2))=μ(sag)−μ(tan) is the distance between the focus positions in sagittal and tangential directions which is astigmatism.

Another parameter that can be derived is the tilt of the image plane relative to the sensor plane. Because of asymmetry of the lens and tilt of the lens relative to the sensor, the image plane can be tilted relative to the sensor plane, as illustrated in FIG. 19 (which shows the tilting effect very much exaggerated for the purposes of illustration). As a consequence, the focus position μ depends on the coordinates of the pixel in the pixel array (x,y), in addition with the sagittal or tangential coordinates. This tilt of sagittal or tangential images can be computed by fitting a plane to the focus positions μ(x,y)−h2. This fitting can be achieved through different algorithm, such as the least square algorithm. Thus the direction of highest slope can be found, which gives both the direction and angle of tilt.

FIG. 20 shows the SFR contour mapping in a radial direction with the vertical and horizontal positions being plotted on the y and x axes respectively. FIG. 21 shows a similar diagram for the tangential edges. This separation of the edges helps in the analysis of images.

For example, the field curvature of the lens can be seen in FIG. 21 as the region 2100, representing a low SFR region showing 45% of the field is not at the same focus as at the center.

Astigmatism of the lens can be seen from a comparison between FIGS. 20 and 21, that is, by analyzing the difference between the radial and tangential components.

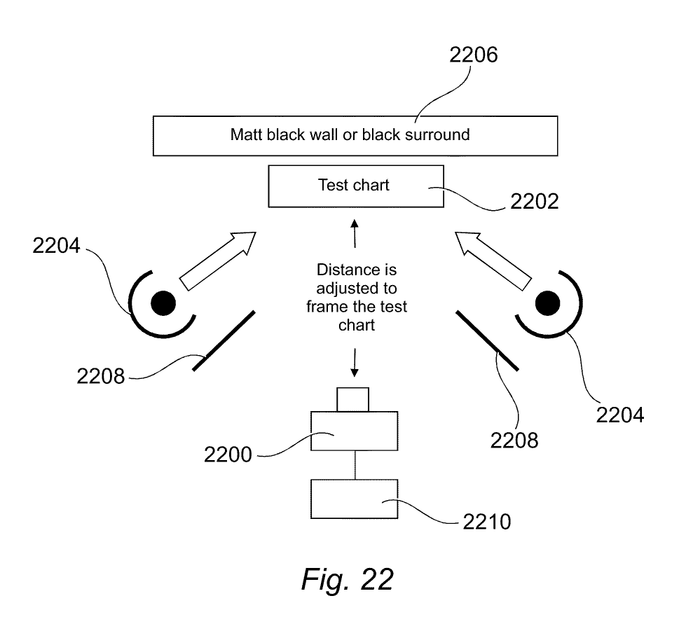

FIG. 22 shows an example test system for the implementation of the invention, which is derived from ISO 12233:2000. A camera 2200 is arranged to image a test chart 2202. The test chart 2202 may be the chart as shown in FIG. 7 or according to variations mentioned herein. Alternatively, the chart 2202 may be a chart that comprises the chart as shown in FIG. 7 or according to variations mentioned herein as one component part of the chart 2202. That is, the chart 2202 may for example be or comprise the chart of FIG. 7.

The chart 2202 is illuminated by lamps 2204. A low reflectance surface 2206, such as a matt black wall or wall surround is provided to minimize flare light, and baffles 2208 are provided to prevent direct illumination of the camera 2200 by the lamps 2204. The distance between the camera 2200 and the test chart 2202 can be adjusted. It may also be possible to adjust the camera 2200 to change the distance between the camera lens and the image sensing array of the camera 2200.

The test system also comprises a computer 2210. The computer 2210 can be provided with an interface to receive image data from the camera 2200, and can be loaded or provided with software which it can execute to perform the analysis and display of the image data received from the camera 2200, to carry out the SFR analysis described herein. The computer 2210 may be formed by taking a general purpose computer, and storing the software on the computer, for example making use of a computer readable medium as mentioned above. When that general purpose computer executes the software, the software causes it to operate as a new machine, namely an image actuance analyzer. The image actuance analyzer is a tool that can be used to determine the SFR or other actuance characteristics of a camera.

In a preferred embodiment, the chart is also provided with markers which act as locators. These are shown in the example chart of FIG. 7 as comprising four white dots 700 although other shapes, positions, number of and colors of markers could be used, as will be apparent from the following description.

The markers can be used to help locate the edges and speed up the edge locating algorithm used in the characterization of the image sensors.

To assist the understanding of the disclosure, a standard SFR calculation process will now be described. The process comprises as an introductory step capturing the image with the camera and storing the image on a computer, by uploading it to a suitable memory means within that computer. For a multi-channeled image sensor (such as a color-sensitive image sensor) a first (color) channel is then selected for analysis.

Then in an edge research step, the edges need to be located. This is typically done either by using corner detection on the image, for example Harris corner detection, to detect the corners of the shapes defining the edges. Shapes may be located on a binarized image, filtered and then have their edges located.

Subsequently, in a first step of an SFR calculation, a rectangular region of interest (ROI) having sides that are along the rows and columns of pixels is fitted to each edge to measure the angle of the edge. The length and height of the ROI depends on the chart and the center of the ROI is the effective center found in the previous step.

The angle of the edge is then measured by differentiating each line of pixels across the edge (along the columns of the pixel array if the vertical contrast is higher than the horizontal contrast, and along the rows otherwise). A centroid formula is then applied to find the edge on each line and then a line is fitted to the centroids to get the angle edge.

Subsequently, a rectangular ROI having sides along and perpendicular to the edge is fitted along each edge. The center of the ROI is the effective center of the edge found in the last step, and the length and height of the ROI depends on the chart.

The SFR measurement of each edge is then carried out. The pixel values from the ROI are binned to determine the ESF. This is then differentiated to obtain the LSF which is then fast Fourier transformed, following which the modulus of that transform is divided by its value at zero frequency, and then corrected for the derivation of a discrete function.

As mentioned above, the steps can be carried out on one channel of the image sensor data. The steps can then be repeated for each different color channel. The x-axis of an ESF plotted is the distance from the edge (plus any offset). Each pixel can therefore be associated with a (data collection) bin based on its distance from the edge. That is, the value of the ESF at a specific distance from the edge is averaged over several values. In the following, pixel pitch is abbreviated as “pp”, and corresponds the pitch between two neighboring pixels of a color channel. For the specific case of an image sensor with a Bayer pattern color filter array, neighboring pixels that define the pixel pitch will be two pixels apart in the physical array.

The association of each pixel with a bin based on its distance from the edge can make use of fractional values of pixel pitch—for example, a separate bin may be provided for each quarter pixel pitch, pp/4, or some other chosen factor. This way, each value is averaged less than if a wider pitch was used, but more precision on the ESF and hence the resultant SFR, is obtained. The image may be oversampled to ensure higher resolution and enough averaging.

This process takes a long time. On a very sharp image, few corners will be found. On the blurred image, several corners will be found. If there are too many corners, filtering them requires a longer time. So the time to process an image is image dependent (which is an unwanted feature for production), and the filtering process can be very memory and time consuming if too many edges are found—indeed, the distance from one corner to another is needed for the interpretation, and a very large matrix calculation needs to be carried out. Also the image processing achieved in order to improve the probability of finding the edge takes a long time.

In contrast to this technique, the use of the markers 700 together with associated software provides new and improved methods which cut down on the time taken to measure the SFR.

First of all, knowledge about the chart is embodied in an edge information file which is stored in the computer. The edge information file comprises an edge list which includes the positions of the center of the chart, the markers, and all the edges to be considered. Each of the edges is labeled, and the x,y coordinates of the edge centers, the angle relative to the direction of the rows and/or columns of pixels, and the length of the edges (in units of pixels) are stored.

Then an image of the chart is captured with the camera and loaded into the computer. For a multi-channeled image sensor (such as a color-sensitive image sensor) a first (color) channel is then selected for analysis.

Subsequently in a first edge research step, the image is binarized. A threshold pixel value is determined, values above which are set to high if the markers are white, or low if the markers are black; or vice versa.

Subsequently, the markers are located. Clusters of high values are found on the binarized image and their center is determined by a centroid formula. The dimension of the clusters is then checked to verify that the clusters correspond to the markers, and then the relative distance between the located markers is analyzed to determine which marker is which.

The measured marker positions are then compared with their theoretical position given by the edge information file. Any difference between the theoretical and measured marker positions can then be used to calculate the offset, rotation and magnification of chart and of the edges within the chart.

The real values of the edge angles and locations can then be determined from the offsets derived from the marker measurements.

Optionally, the position of the edges can then be refined by scanning the binarized image along and across the estimated edges to find its center. This fine edge search is achieved to ensure that the edge is centered in the ROI. It also ensures that no other edge is visible in the ROI. This effectively acts as a verification of the ROI position.

Subsequently, a rectangular ROI is fitted along each edge, that has sides parallel and perpendicular to the edge. The center of the ROI is the effective center found in the last step (that is, as found in the fine edge search, or the coarse edge search if the fine edge search has not been carried out). The length is given in the edge information file, and is parallel to the edge. The length given in the edge information file could be resized if necessary. The width needs to be large enough to ensure there is enough data to be collected from the edge. As above, the size can be measured in pixels. The width can also be perpendicular to the edge.

As an example, and for illustrative purposes only, the width of the ROI could be chosen to be 32 pixels. The final 4× oversampled ESF could then be 128 samples long (=32×4), meaning that the LSF sample length=128 * (pp/4). The FFT is a discrete function, and the distance between two frequencies is 1/LSF_length=1/(128*(pp/4)) beginning frequency=0. So Ny/4 is directly output by the FFT since on a Bayer image Ny/4=1/(4*pp)=8 * 1/(128*(pp/4)). There is no interpolation required, so no time consumed.

Subsequently, the SFR is measured as above.

It can be seen therefore that the process of SFR measurement is much quicker than in the prior art. The combination of the positions and identification of the markers with the edge information file to generate a set of estimated edge positions is much quicker than the prior art method, that relies on analyzing the entire image. Effectively, the standard edge detection step is skipped in favor of the location of the markers, the calculation of marker offsets, and determining the edge positions from those measured offsets. With the locators, the coarse edge search does not need any image processing. Instead, the center of the edge in the ROI simply needs to be located in order to re-center the edge.

The invention provides many advantages. Performing module level resolution measurements across the entire image with differentiation between the radial and tangential components allows direct lens level to module level resolution comparison and enables direct measurement of lens field curvature and astigmatism via module level measurements. Thus, which a quality or performance assessment of a lens or module in terms of resolution or sharpness (at different object distances) can be performed, in order to assess the lens or the module against specifications, models, simulations, design, theory, or customer expectations.

The direct correlation between lens resolution characteristics and module resolution characteristics also allows faster lens tuning and better lens to module test correlation which implies reduced test guardbands, improved yields and reduced cost.

Furthermore, the methods of this disclosure allows for very good interpolation of the resolution across all the image.

Various improvements and modifications may be made to the above without departing from the scope of the invention. It is also to be appreciated that the charts mentioned may be formed as the entire and only image on a test chart, or that they may form a special SFR subsection of a larger chart that comprises other features designed to test other image characteristics.

1. A method of characterizing a camera module that comprises an image sensor and an optical element, comprising
imaging an object with the camera module;
measuring a resolution metric from the obtained image;
determining a point or points where the resolution metric is maximized, each said point representing a measured in-focus position; and
using the measured in-focus positions to derive optical aberration parameters.

2. The method of claim 1, wherein measuring a resolution metric from the obtained image comprises measuring said resolution metric at a plurality of points across a field of view.

3. The method of claim 1, further comprising:
adjusting the relative position between at least two components selected from the group consisting of the image sensor, the optical element and the object;
imaging the object at said adjusted relative position;
measuring said resolution metric from the image obtained at said adjusted relative position;
determining a point or points where the resolution metric is maximized, each said point representing an in-focus position at the adjusted relative position;
making a comparison between the in-focus positions at an original position and the adjusted relative position; and
using the measured in-focus positions to derive optical aberration parameters.

4. The method of claim 3, wherein adjusting the relative position comprises moving the image sensor with respect to the optical element.

5. The method of claim 3, wherein adjusting the relative position comprises moving the object with respect to the optical element.

6. The method of claim 1, further comprising:
adjusting a relative position by moving the image sensor with respect to the optical element;
adjusting a relative position by moving the object with respect to the optical element;
correlating a Through Focus Curve obtained from the movement of the sensor with respect to the optical element with a Through Focus Curve obtained from the movement of the object with respect to the optical element.

7. The method of claim 6, comprising fitting the Through Focus Curve with a function of the distance between the optical element and the image sensor which is injective from real to real.

8. The method of claim 7, wherein the function is Gaussian.

9. The method of claim 7, further comprising using different functions at different field positions.

10. The method of claim 3, wherein using the measured focus positions to derive optical aberration parameters comprises:
comparing the focus position between the original and adjusted positions for a plurality of field positions; and
determining a measure of field curvature for a given field position by comparing the focus position for the field position with respect to the focus position for a central field position.

11. The method of claim 10, comprising combining a plurality of field curvature measurements to build a representation of the field curvature of the camera module.

12. The method of claim 11, further comprising comparing said representation with an ideal Petzval surface in order to identify undesired field curvature effects.

13. The method of claim 1, wherein using the measured focus positions to derive optical aberration parameters comprises measuring a separation between a tangential conjugate and a sagittal conjugate.

14. The method of claim 1, wherein using the measured focus positions to derive optical aberration parameters comprises fitting a plane to the focus positions determined at a plurality of points corresponding to pixel array positions of the image sensor.

15. The method of claim 1, wherein the resolution metric is a spatial frequency response (SFR).

16. The method of claim 1, wherein the object imaged with the camera module comprises a test chart that comprises a pattern with one or more edges along a radial direction with respect to the plane of the optical element and one or more edges along a tangential direction with respect to the plane of the optical element.

17. The method of claim 16, wherein the area of the test chart pattern is substantially filled by shapes that have edges that are either radial or tangential.

18. The method of claim 16, wherein the shapes of the pattern defining the edges are organized circularly, corresponding to the rotational symmetry of a lens.

19. The method of claim 16, wherein the edges are offset from the horizontal and vertical positions by at least two degrees.

20. The method of claim 19 wherein the pattern is such that, upon rotation of the chart by up to or around ten degrees, the edges will all remain slightly offset from the horizontal and vertical positions.

21. The method of claim 16, wherein the resolution metric is a spatial frequency response (SFR).

22. A method of characterizing a digital image sensing device comprising:
imaging a test chart with the digital image sensing device, said test chart comprising a pattern that defines a plurality of edges and a plurality of markers;
locating said markers in the image obtained by the digital image sensing device;
comparing the measured marker positions with known theoretical marker positions;
calculating a difference between the theoretical and actual marker positions;
determining edge locations based on said calculated difference; and
measuring a resolution metric from the obtained image at the edge locations thus determined.

23. The method of claim 22, wherein determining edge locations comprises determining one or more of an offset, rotation or magnification of chart and/or of the edges within the chart.

24. The method of claim 22, wherein locating said markers in the image obtained by the digital image sensing device comprises identifying the markers.

25. The method of claim 22, wherein comparing the measured marker positions with known theoretical marker positions comprises looking up an edge information electronic file, which comprises an edge list which includes the positions of the center of the chart, the markers, and the edges.

26. The method of claim 25, wherein the positions of the edges comprise the co-ordinates of the edge centers, the angle relative to the direction of the rows and/or columns of pixels of an image sensing array of the digital image sensing device, and the length of the edges.

27. The method of claim 22, wherein the digital image sensing device is a camera module comprising an image sensor and an optical element.

28. The method of claim 22, wherein the object imaged with the digital image sensing device comprises a test chart that comprises a pattern with one or more edges along a radial direction with respect to the plane of the optical element and one or more edges along a tangential direction with respect to the plane of the optical element.

29. The method of claim 28, wherein the area of the test chart pattern is substantially filled by shapes that have edges that are either radial or tangential.

30. The method of claim 28, wherein the shapes of the pattern defining the edges are organized circularly, corresponding to the rotational symmetry of a lens.

31. The method of claim 28, wherein the edges are offset from the horizontal and vertical positions by at least two degrees.

32. The method of claim 31, wherein the pattern is such that, upon rotation of the chart by up to or around ten degrees, the edges will all remain slightly offset from the horizontal and vertical positions.

33. The method of claim 22, wherein the resolution metric is a spatial frequency response (SFR).

34. Apparatus for the characterization of a digital image sensing device comprising:
a test chart;
a digital image sensing device; and
a computer connectable to a digital image sensing device and configured to receive image data from the device and to perform calculations for the performance of a method of characterizing a camera module that comprises an image sensor and an optical element, comprising:
imaging an object with the camera module;
measuring a resolution metric from the obtained image;
determining a point or points where the resolution metric is maximized, each said point representing a measured in-focus position; and
using the measured in-focus positions to derive optical aberration parameters.

35. Apparatus for the characterization of a digital image sensing device comprising:
a test chart;
a digital image sensing device; and
a computer connectable to a digital image sensing device and configured to receive image data from the device and to perform calculations for the performance of a method of characterizing a digital image sensing device comprising:
imaging a test chart with the digital image sensing device, said test chart comprising a pattern that defines a plurality of edges and a plurality of markers;
locating said markers in the image obtained by the digital image sensing device;
comparing the measured marker positions with known theoretical marker positions;
calculating a difference between the theoretical and actual marker positions;
determining edge locations based on said calculated difference; and
measuring a resolution metric from the obtained image at the edge locations thus determined.

36. A computer program product downloaded or downloadable onto, or provided with, a computer that, when executed, enables the computer to perform calculations for the performance of a method of characterizing a camera module that comprises an image sensor and an optical element, comprising:
imaging an object with the camera module;
measuring a resolution metric from the obtained image;
determining a point or points where the resolution metric is maximized, each said point representing a measured in-focus position; and
using the measured in-focus positions to derive optical aberration parameters.

37. A computer program product downloaded or downloadable onto, or provided with, a computer that, when executed, enables the computer to perform calculations for the performance of a method of characterizing a digital image sensing device comprising:
imaging a test chart with the digital image sensing device, said test chart comprising a pattern that defines a plurality of edges and a plurality of markers;
locating said markers in the image obtained by the digital image sensing device;
comparing the measured marker positions with known theoretical marker positions;
calculating a difference between the theoretical and actual marker positions;
determining edge locations based on said calculated difference; and
measuring a resolution metric from the obtained image at the edge locations thus determined.
